(19) United States
(12) Patent Application Publication
(10) Pub. No.: US 2005/0091370 A1
(43) Pub. Date: Apr. 28, 2005

(54) Method for monitoring data transmissions

(75) Inventor: Christian Wietfeld, Falkensee (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/860,600

(22) Filed: Jun. 4, 2004

(30) Foreign Application Priority Data
Jun. 6, 2003 (EP) 03090176.3

(51) Int. Cl. G06F 15/173

(52) U.S. Cl. 709/224

(57) ABSTRACT

Monitoring data transmissions in a telecommunication network between a service user computer belonging to a service user and a service computer. A service request message from the service user computer prompts an intermediate node in the telecommunication network, which intermediate node is arranged between the service user computer and the service computer providing the requested service, to transmit an intermediate-node service request message to the service computer. The intermediate node then receives a service message from the service computer, which service message includes user data for the requested service and a service use parameter associated with the service, and the intermediate node reads the service use parameter from the service message and transmits it to a central parameter storage system in the telecommunication network. The parameter storage system stores the service use parameter on a user related basis, and the intermediate node transmits the user data to the service user computer.

### CLAIM FOR PRIORITY

This application claims the benefit of priority to European Application No. 03090176.3, filed on Jun. 6, 2003 in the German language, the contents of which are hereby incorporated by reference.

### TECHNICAL FIELD OF THE INVENTION

The invention relates to a method for monitoring data transmissions between a service user computer belonging to a service user and a service computer.

### BACKGROUND OF THE INVENTION

In modern telecommunication networks (Internet, telephone landline networks or mobile radio networks), it is generally known practice to provide network users with a multiplicity of services. Such services may be, by way of example, voice data transmission services, or else services which involve the electronic delivery of information (e.g. messages, market prices or images) or the electronic ordering of material goods (e.g. books). The various service providers associated with such services each have computer systems (service computers) which are able to communicate with a computer belonging to a service user (service user computer). These service computers may be arranged within the telecommunication network; alternatively, they may be arranged outside of the telecommunication network and connected thereto. Service providers with such service computers arranged outside of the telecommunication network are often referred to as “third party service providers” and are not subject to the control of an operator of the respective telecommunication network.

A telecommunication network can thus be used to transmit a multiplicity of messages relating to instances of service use.

### SUMMARY OF THE INVENTION

The invention discloses a method which can be used in a telecommunication network to ascertain information about the services which are being used by virtue of the telecommunication network.

In one embodiment of the invention, there is a method for monitoring data transmissions in a telecommunication network between a service user computer belonging to a service user and a service computer, in which a service request message from the service user computer prompts an intermediate node in the telecommunication network, which intermediate node is arranged, in terms of message flow, between the service user computer and the service computer providing the requested service, to transmit an intermediate-node service request message to the service computer, the intermediate node then receives a service message from the service computer, which service message contains user data for the requested service and a service use parameter associated with the service, the intermediate node reads the service use parameter from the service message and transmits it to a central parameter storage system in the telecommunication network, the parameter storage system stores the service use parameter on a user related basis, and the intermediate node transmits the user data to the service user computer.

This method advantageously allows service use parameters relating to the use of a wide variety of services to be collected. This may also cover such services as are provided by technical facilities outside of the telecommunication network, these facilities not being subject to the control of a telecommunication network operator.

In another embodiment of the invention, the stored service use parameters are used by the parameter storage system to assign the service user to a service user group. In this case, the number and/or type of stored service user parameters may be used by the parameter storage system to assign the service user to the service user group.

This advantageously allows the service user computers or the associated service users to be combined into service user groups according to the type of use of the services (examples of such service user groups would be, by way of example, nonusers, rare users, regular users).

In still another embodiment of the invention, the intermediate node authenticates the service user upon the arrival of the service request message, the parameter storage system transmits a group information item to the intermediate node via the service user group associated with the service user, the intermediate node appends the group information item to the intermediate-node service request message, and the group information item is transmitted to the service computer with the intermediate-node service request message. In this way, it is possible to transmit to the service computer that user group to which the user requesting a service belongs directly when a service is requested.

In yet another embodiment of the invention, the service computer provides service-user group specific user data for the service message on the basis of the group information item received. The method may also proceed such that the service computer provides service-user group specific service use parameters for the service message on the basis of the group information item received. This allows the service computers and their service providers to provide particular services (“premium content”) to the respective service user on the basis of group or to allocate group specific service use parameters (“bonus points”) for use of a service.

In another embodiment of the invention, a service use parameter is used which includes an identity feature for the service computer, an identity feature for the requested service and/or a value statement associated with the service. This allows the parameter storage system to collect and store information about implemented service uses on a service specific basis.

The inventive method may involve the service use parameters stored in the parameter storage system being deleted after a preselected time period has elapsed. This has the advantage that no storage space in the parameter storage system is taken up by older data which are therefore of no interest to the service providers' current business.

In another embodiment of the invention, the intermediate-node service request message used may be a message which is based on HTTP stipulations and whose HTTP header is used to transmit the group information item. The method may also involve the service message used being a message which is based on HTTP stipulations and whose HTTP header is used to transmit the service use parameter. This embodiment of the invention advantageously allows service computers to be equipped to use the inventive method quickly and inexpensively, since the service computers merely need to be able to receive and send messages in the known HTTP (Hyper Text Transfer Protocol) format.

In still another embodiment of the invention, a service user request for special services may involve the intermediate node receiving special service use parameters which prompt the parameter storage system to delete service use parameters which are stored therein. This allows the invention to be used to implement a “bonus system” in which, by way of example, toll-free services may be provided as special services when service use parameters used as “bonus points” are present.

### BRIEF DESCRIPTION OF THE DRAWINGS

The invention is described in more detail below with reference to the drawing, in which:

FIG. 1 shows an example of method steps according to the invention.

### DETAILED DESCRIPTION OF THE INVENTION

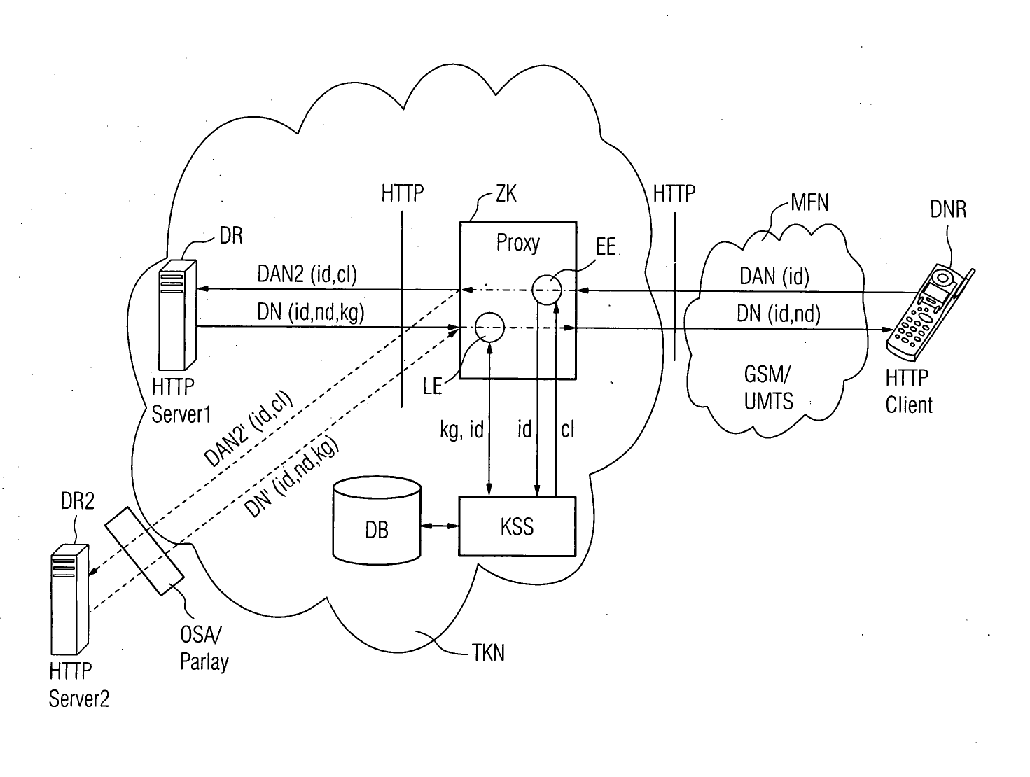

FIG. 1 shows a service user computer in the form of a mobile telephone DNR which a service user uses to request a service (which is the electronic delivery of an image, for example) from a service computer DR. To this end, the service user computer DNR is connected to a telecommunication network TKN via a mobile radio network MFN (for example via a GSM or UMTS mobile radio network). The telecommunication network TKN may be, by way of example, the Internet or another mobile radio network. In another exemplary embodiment, the service user computer DNR may also be connected directly to the telecommunication network TKN. In this case, the interposed mobile radio network MFN is not necessary. In another example, the service user computer DNR may also be a personal computer or a Notebook which is connected to the telecommunication network TKN (possibly via an access network).

To request a service from the service computer DR, the service user computer DNR sends a service request message DAN, which includes a mobile radio telephone number for the service user computer DNR as an identification feature id, to the service computer DR. This service request message DAN is sent via the mobile radio network MFN to the telecommunication network TKN, where it arrives at an intermediate node ZK in the form of a proxy computer which is arranged, in terms of message flow, between the service user computer DNR and the service computer DR. The intermediate node ZK is connected to a parameter storage system KSS in the telecommunication network TKN. A database DB connected to the parameter storage system KSS stores service use parameters for a multiplicity of service users, these service users having already requested a service from a service computer via the intermediate node in the past. As such a service use parameter, one or more of the variables mentioned below may be stored, for example: an identity feature (for example an Internet address) for the respective service computer, an identity feature (e.g. “image delivery service”) for a requested service and/or a value statement (e.g. service value [symbol] 100, 200 bonus points) associated with such a service. These service use parameters are summed on a user specific basis in the parameter storage system KSS (e.g. the following information may be stored in the database: “the user in question has already used services from the service computer DR 15 times, including the “image delivery service” 7 times, has paid [symbol] 117 for the image deliveries and has received 234 bonus points in return”). These summed service use parameters are used by the parameter storage system KSS to assign the service user or the service user computer DNR to a service user group cl. Thus, in this exemplary embodiment, the service user computer DNR is assigned to the service user group “regular users”, since more than 200 bonus points have already been summed for the service user computer in the parameter storage system KSS. Similarly, in another exemplary embodiment, the association may be in a form such that a service user is assigned to a service user group “regular users of image service” as soon as he has requested the service “image service” 10 times.

As soon as the service request message DAN arrives at the intermediate node ZK, an identification unit EE at the intermediate node authenticates the service user computer DNR or the service user, i.e. the latter's identity is ascertained. In the exemplary embodiment, this is done by virtue of the mobile radio telephone number id being read from the service request message DAN and being transmitted to the parameter storage system KSS. The parameter storage system KSS uses the mobile radio telephone number id to read the entry associated with the service user from the database DB, ascertains the service user group (“regular users”) and sends a group information item cl about the service user group “regular users” associated with the service user back to the intermediate node ZK. The intermediate node ZK inserts the group information item cl into the header of the service request message DAN. This results in an intermediate-node service request message DAN2, which is then transmitted from the intermediate node ZK to the service computer DR.

The service computer DR, which, in the exemplary embodiment, is an HTTP server in the telecommunication network TKN, reads the mobile radio telephone number id, the group information item cl and information about the requested service from the intermediate-node service request message DAN2. Since the service user belongs to the service user group “regular users”, the service computer DR provides the requested image data in a particularly high quality (for example at a high resolution). These image data are service-user group specific user data, since images at this high resolution are provided only for “regular users”. Since the service user belongs to the service user group “regular users”, he also receives a larger number of bonus points (for example three bonus points per [symbol] of sales) as a credit for his service request than would be received, by way of example, by a service user in the service user group “rare users”. The service computer DR thus takes the group information item cl received as a basis for providing service-user group specific service parameters kg, which, in the exemplary embodiment, contain the Internet address of the service computer DR, the identity feature “high resolution image delivery service” and the value statement “ [symbol] 12, 36 bonus points” for the requested service. These data are sent back to the mobile radio telephone number id of the service user computer DNR as service use parameter kg, together with the image data (user data) nd, using a service message DN. In this case, the service message DN used is a message which is based on HTTP stipulations and whose header is used to transmit the service use parameter kg.

The service message DN is sent to the intermediate node ZK. At the intermediate node ZK, a reading unit LE reads the service use parameter kg and the mobile radio telephone number id from the service message DN and transmits them to the parameter storage system KSS. The mobile radio telephone number id is used by the parameter storage system KSS to store selected or all variables in the service use parameter kg in the database DB. In this case, the new 36 bonus points are added to the 234 bonus points which already exist, and the total of 270 bonus points is stored in the database DB. As a result, a central unit (parameter storage system KSS with database DB) in the telecommunication network TKN stores information about the image delivery service which was requested via the intermediate node ZK in the telecommunication network TKN. Finally, the user data nd are transmitted in the form of the high resolution image data from the intermediate node to the service user computer DNR using the service message DN. This completes provision of the service for the service user computer DNR.

In a further procedure, the service user computer DNR could, by way of example, request a further service from a further service computer DR2, this further service computer DR2 possibly being situated outside of the telecommunication network TKN. In this case, the intermediate node ZK would send an intermediate-node service request message DAN2′, similar to the intermediate-node service request message DAN2 described above, to the second service computer DR2 via an OSA/Parlay gateway. To provide the service, the second service computer DR2 would then send a second service message DN′, similar to the service message DN described above, back to the intermediate node ZK. In this case, the basic sequences correspond to the basic sequences illustrated above.

The service use parameters stored in the parameter storage system KSS may be stored together with a validity period in the database DB. When the preselected validity period has elapsed, these service use parameters are deleted from the database. As soon as a preselected number of service use parameters has been stored for a user in the parameter storage system KSS (for example at least 100 bonus points), the service user computer DNR can request a special service in the form of a toll-free image delivery from the service computer DR. Together with the user data (free image) for this requested special service, the service computer DR sends a special service use parameter to the intermediate node ZK, the special service use parameter including a negative value statement (e.g. minus 100 bonus points) associated with the special service. This special service use parameter is transmitted to the parameter storage system KSS in a known manner and, upon storage in the database DB, when the negative bonus points are added to the bonus points already stored there, results in 100 bonus points already stored there being deleted. In this embodiment of the method, this may additionally be used for redeeming bonus points for attractive special services.

The inventive method has a series of advantages. The service use parameters are transmitted in the headers of HTTP messages as part of the HTTP message traffic (“inband data transmission”). As a result, transmission of the service use parameters requires no separate messages and no separate interfaces. The group information item about the service user group associated with the service user is likewise transmitted as part of the HTTP message traffic to the service computers involved in the method. This data transmission also requires no separate interfaces. The service computers can be integrated into the method with minimal complexity, since the service computers merely need to be able to receive and send HTTP messages and to know the corresponding format of the HTTP header in order to read the group information item from the HTTP header of the intermediate-node service request message DAN2 and to insert the service use parameter kg into the header of the service message DN.

The service use parameters are allocated exclusively by the service computers (application server, HTTP server), which means that no administrative complexity arises in this regard for the operator of the parameter storage system. Newly appearing service use parameters from all of the connected service computers DR, DR2 etc., are recorded centrally and are stored in the database DB without any time delay directly when the service is provided. The use of special service use parameters allows attractive special services, such as “free services in return for parameter redemption”, to be provided for the service users. Since monitoring of the data transmission requires use of the intermediate node ZK and hence use of the telecommunication network TKN even when external service computers are used (such as the service computer DR2), a high level of customer loyalty from the service user with his service user computer DNR to the telecommunication network TKN is also generated.

1. A method for monitoring data transmissions in a telecommunication network between a service user computer belonging to a service user and a service computer, comprising:
prompting, via a service request message from the service user computer, an intermediate node in the telecommunication network, which intermediate node is arranged, in terms of message flow, between the service user computer and the service computer providing a requested service, to transmit an intermediate-node service request message to the service computer;
receiving, at the intermediate node, the service message from the service computer, which service message includes user data for the requested service and a service use parameter associated with the service;
reading, by the intermediate node, the service use parameter from the service message and transmitting the service use parameter to a parameter storage system in the telecommunication network;
storing, in the parameter storage system, the service use parameter on a user related basis; and
transmitting, by the intermediate node, the user data to the service user computer.

2. The method as claimed in claim 1, wherein the stored service use parameters are used by the parameter storage system to assign the service user to a service user group.

3. The method as claimed in claim 2, wherein the number and/or type of stored service user parameters is/are used by the parameter storage system to assign the service user to the service user group.

4. The method as claimed in claim 2, wherein
the intermediate node authenticates the service user upon arrival of the service request message,
the parameter storage system transmits a group information item to the intermediate node via the service user group associated with the service user,
the intermediate node appends the group information item to the intermediate-node service request message, and
the group information item is transmitted to the service computer with the intermediate-node service request message.

5. The method as claimed in claim 4, wherein the service computer provides service-user group specific user data for the service message based on the group information item received.

6. The method as claimed in claim 4, wherein the service computer provides service-user group specific service use parameters for the service message based on the group information item received.

7. The method as claimed in claim 1, wherein the service use parameter is used which includes an identity feature for the service computer, an identity feature for the requested service and/or a value statement associated with the service.

8. The method as claimed in claim 1, wherein the service use parameters stored in the parameter storage system are deleted after a pre-selected time period has elapsed.

9. The method as claimed in claim 4, wherein the intermediate-node service request message is a message which is based on HTTP stipulations and has an HTTP header used to transmit the group information item.

10. The method as claimed in claim 1, wherein the service message used is a message which is based on HTTP stipulations and has an HTTP header used to transmit the service use parameter.

11. The method as claimed in claim 1, wherein the service user request for special services involves the intermediate node receiving special service use parameters which prompt the parameter storage system to delete service use parameters which are stored therein.
